(19) United States
(12) Patent Application Publication
(10) Pub. No.: US 2014/0049021 A1
(43) Pub. Date: Feb. 20, 2014

(54) ROAD HOLDING ABILITY MECHANISM FOR THE TWO FRONT WHEELS OF A MOTORCYCLE

(71) Applicants: Huei-Huay HUANG, Tainan City (TW); Chin-Chi LIN, Tainan City (TW)

(72) Inventors: Huei-Huay HUANG, Tainan City (TW); Chin-Chi LIN, Tainan City (TW)

(73) Assignee: Aeon Motor Co., Ltd., Tainan City (TW)

(21) Appl. No.: 13/584,858

(22) Filed: Aug. 14, 2012

(51) Int. Cl. B62D 9/04

(52) U.S. Cl. 280/267

(57) ABSTRACT

The present invention provides a road holding ability mechanism applied to a motorcycle with two wheels in front. The mechanism may be configured on a three-wheeled motorcycle which has two front wheels and a single rear wheel or on a four-wheeled motorcycle with two front wheels as well as two rear wheels. Under any operating condition, the mechanism enables the two front wheels to offer great road holding ability, that is, to remain stable when moving so as to ensure the motorcycle against rollovers. The present invention includes a simple and innovative structure.

### BACKGROUND OF THE INVENTION

1. Field of the Invention

The present invention generally relates to a road holding ability mechanism for a motorcycle with two wheels in front, in particular, to a mechanism which may control the two front wheels to turn/travel toward the desired course, to tilt and to move up and down in an upright manner. The present invention includes a simple and innovative structure.

2. Description of the Prior Art

A three-wheeled motorcycle is commonly provided with a single rear wheel and two front wheels consisting of a right front wheel as well as a left front wheel. A four-wheeled scooter includes two front wheels arranged with a right front wheel as well as a left front wheel and two rear wheels consisting of a right rear wheel as well as a left rear wheel. A three-wheeled or four-wheeled motorcycle offers more stability and safety than a two-wheeled motorcycle with a single front wheel and a single rear wheel. When cornering and encountering inclined or uneven and bumpy road surfaces, especially the road surface with height-differences, the surfaces of the two front wheels need to keep in contact with the ground surface to allow the two front wheels to remain stable so as to enable the motorcycle to be able to steer safely to avoid rollovers. As disclosed in the prior art, Taiwan invention patent number I331973, the three-wheeled scooter with a road holding ability mechanism for the front wheels is provided with a steering and suspension mechanism to prevent the wheels from being off the ground so as to avoid rollovers when the vehicle corners and leans. The structure of said prior art is built of linkages, that is, said prior art includes plenty of structure assemblies, so its product cost is high. However, the present invention includes a simple and innovative structure that may save product cost.

### SUMMARY OF THE INVENTION

It is a primary object of the present invention to provide a road holding ability mechanism having a simple structure for the two front wheels of a motorcycle to permit the two front wheels to maintain their great road holding ability so as to stay stable under any operating condition.

According to the main feature of the present invention, the mechanism is arranged with two front wheel brackets for supporting the two front wheels. Each front wheel bracket is respectively coupled with a connecting arm secured to a connecting base. The connecting base and a steering shaft that directs the front wheels to a desired direction of motion are controlled by a controller so as to enable the connecting base to be able to tilt simultaneously with the steering shaft when the steering shaft tilts. Besides, the connecting base will stay fixed and remain in the same place when the steering shaft performs in-place clockwise or counterclockwise rotation. Each of the two connecting arms, on the top surface thereof, is respectively configured with a shock absorber pivotally connected with the motorcycle frame, and the buffer action forces from both of the shock absorbers are interconnected so as to keep the front wheels in contact with the ground surface. The steering shaft for controlling the direction of the two front wheels' motion is provided in coupling with an anchor plate which may simultaneously operate together with the steering shaft. The anchor plate is arranged with a right steering linkage and a left steering linkage respectively connected to the relative front wheel bracket so as to enable the handlebar to be able to control the direction of the two front wheels' motion. In addition, the connecting base is provided in coupling with an extension plate which may simultaneously perform together with the connecting base. The extension plate, on each of both sides thereof, is respectively configured with a linkage which is attached to the relative front wheel bracket and may drive the relative front wheel to tilt, so that the two linkages may drive the two front wheels to tilt simultaneously when the steering shaft tilts.

### BRIEF DESCRIPTION OF THE DRAWINGS

In order that the present invention may be more fully understood, a preferred embodiment thereof will now be described with reference to the accompanying drawings, in which:

FIG. 1 is a stereogram showing the structure of the front-wheel portion according to the preferred embodiment of the present invention.

FIG. 2 is an elevation showing the structure of the front-wheel portion according to the preferred embodiment of the present invention.

FIG. 3 is a top view showing the structure of the front-wheel portion according to the preferred embodiment of the present invention.

FIG. 4 is an elevation showing the front wheels turning left according to the preferred embodiment of the present invention.

FIG. 5 is a top view showing the front wheels turning left according to the preferred embodiment of the present invention.

FIG. 6 is an elevation showing the front wheels turning right according to the preferred embodiment of the present invention.

FIG. 7 is a top view showing the front wheels turning right according to the preferred embodiment of the present invention.

FIG. 8 is an elevation showing the front wheels tilting to the left according to the preferred embodiment of the present invention.

FIG. 9 is a top view showing the front wheels tilting to the left according to the preferred embodiment of the present invention.

FIG. 10 is an elevation showing the front wheels tilting to the right according to the preferred embodiment of the present invention.

FIG. 11 is a top view showing the front wheels tilting to the right according to the preferred embodiment of the present invention.

FIG. 12 is an elevation showing the front wheels tilting to the left and turning according to the preferred embodiment of the present invention.

FIG. 13 is a top view showing the front wheels tilting to the left and turning according to the preferred embodiment of the present invention.

FIG. 14 is an elevation showing the front wheels tilting to the right and turning according to the preferred embodiment of the present invention.

FIG. 15 is a top view showing the front wheels tilting to the right and turning according to the preferred embodiment of the present invention.

### DESCRIPTION OF THE PREFERRED EMBODIMENTS

The means for achieving the aforesaid objective and the functions of the present invention will become apparent from the following description, taken in connection with the accompanying drawings, wherein a preferred embodiment of the present invention is disclosed.

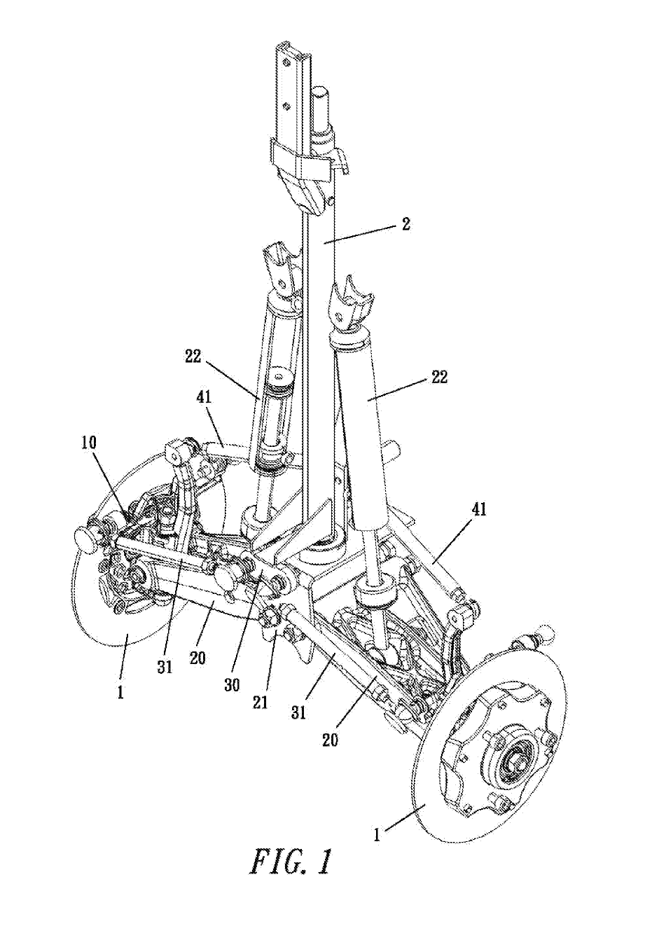

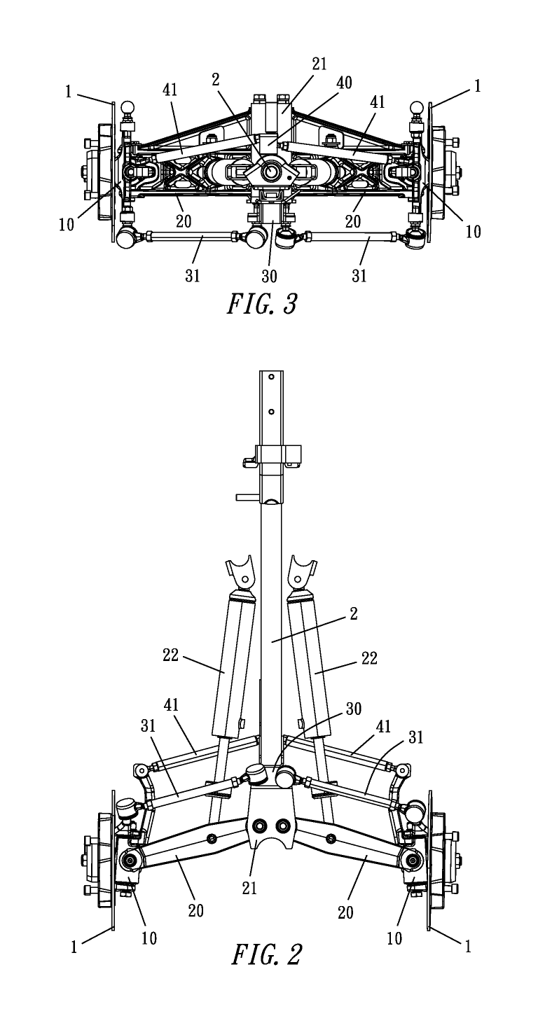

Firstly, the motorcycle with two wheels in front disclosed in the present invention is the motorcycle having two front wheels consisting of a right front wheel and a left front wheel (The outer tires are not depicted in the figures.), and a single rear wheel or two rear wheels respectively arranged on the right side and the left side. Referring to FIGS. 1 to 3, the present invention, the road holding ability mechanism (a tilting, steering and suspension mechanism) for controlling the two front wheels 1 comprises two front wheel brackets 10 for supporting the two front wheels 1 respectively coupled with a connecting arm 20 which is secured to a connecting base 21 between the connecting arms, a steering shaft 2 whose top end is attached to a handlebar of the motorcycle for directing the front wheels 1 to turn/travel toward a desired direction of motion and whose bottom end as well as the connecting base 21 are managed by a controller so as to control the connecting base 21 not only to be able to tilt simultaneously with the steering shaft 2 when the shaft 2 tilts but also to be able to stay fixed in the same place without turning simultaneously with the steering shaft 2 when the shaft 2 performs in-place clockwise or counterclockwise rotation, two hydraulic damper 22 (shock absorbers) whose hydraulic circuits are interconnected and each of which has a upper end pivotally connected with the motorcycle frame as well as a bottom end secured to the top surface of the relative connecting arm 20, an anchor plate 30 attached to the steering shaft 2 so as to be able to simultaneously operate together with the shaft 2 and arranged with a right steering linkage 31 as well as a left steering linkage 31 which are respectively connected to the relative front wheel bracket 10, and an extension plate 40 (as shown in FIG. 3 and FIG. 5) which is provided in coupling with the connecting base 21 so as to be able to simultaneously perform together with the connecting base 21 and which is configured with a right linkage 41 and a left linkage 41 respectively attached to the relative front wheel bracket 10.

FIGS. 1 to 3 shows a completed combination of the foresaid assemblies.

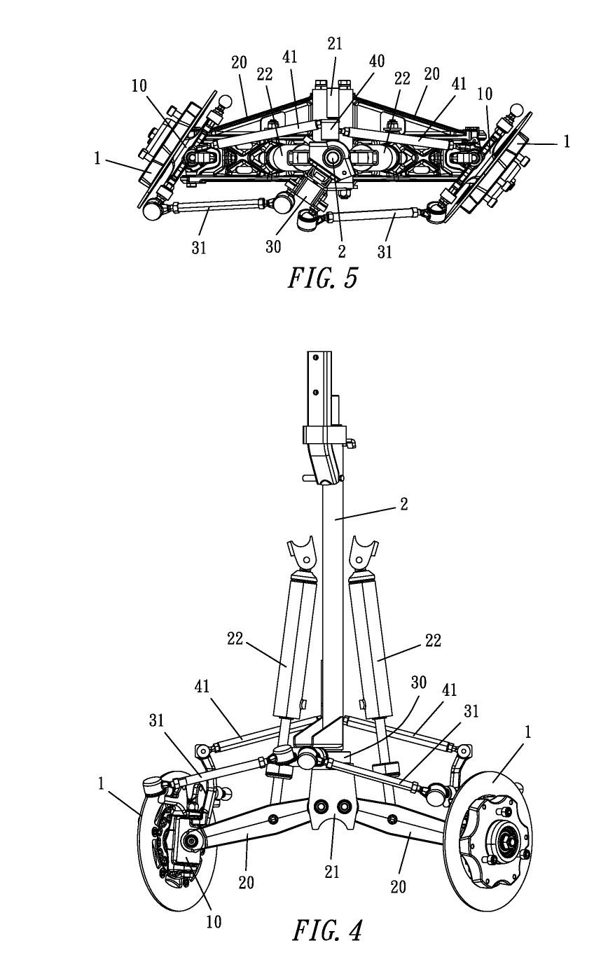

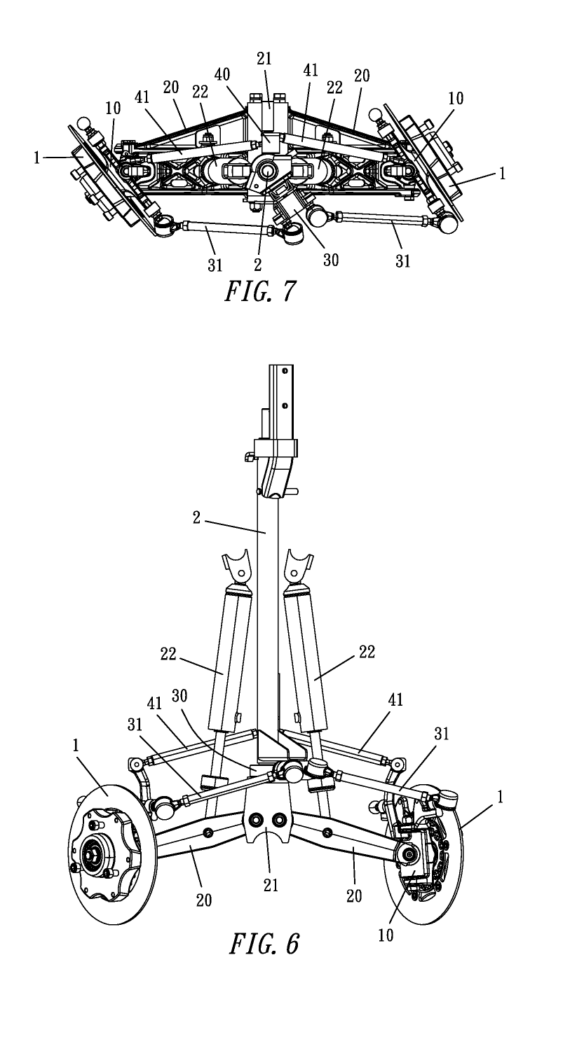

Referring to FIGS. 4 to 7, the anchor plate 30 operates together with the shaft 2 so as to actuate the two steering linkages 31 to direct the two front wheels 1 simultaneously to the desired direction when the steering shaft 2 turns/performs for driving the two front wheels 1 to travel toward a desired course.

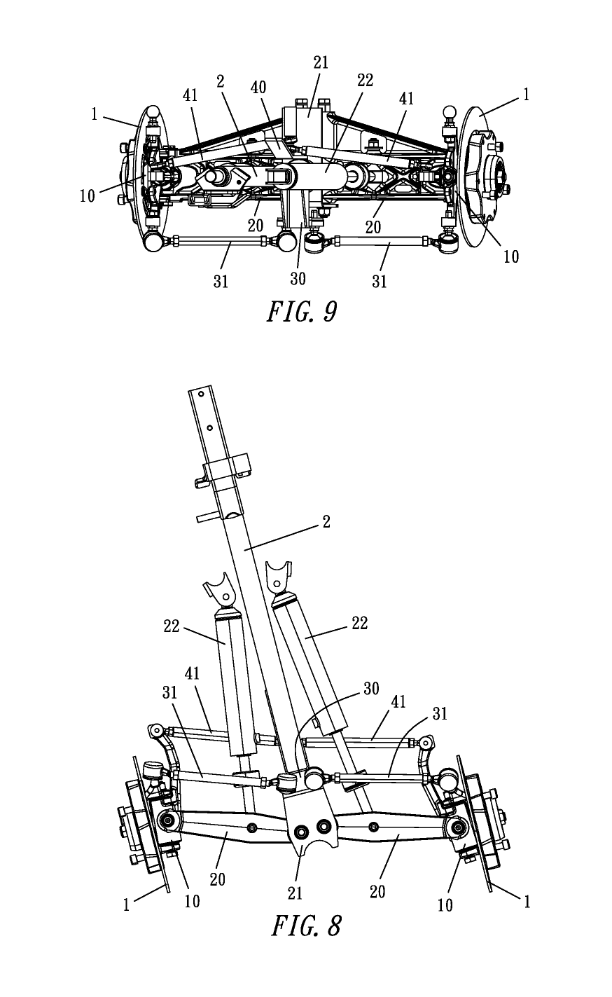

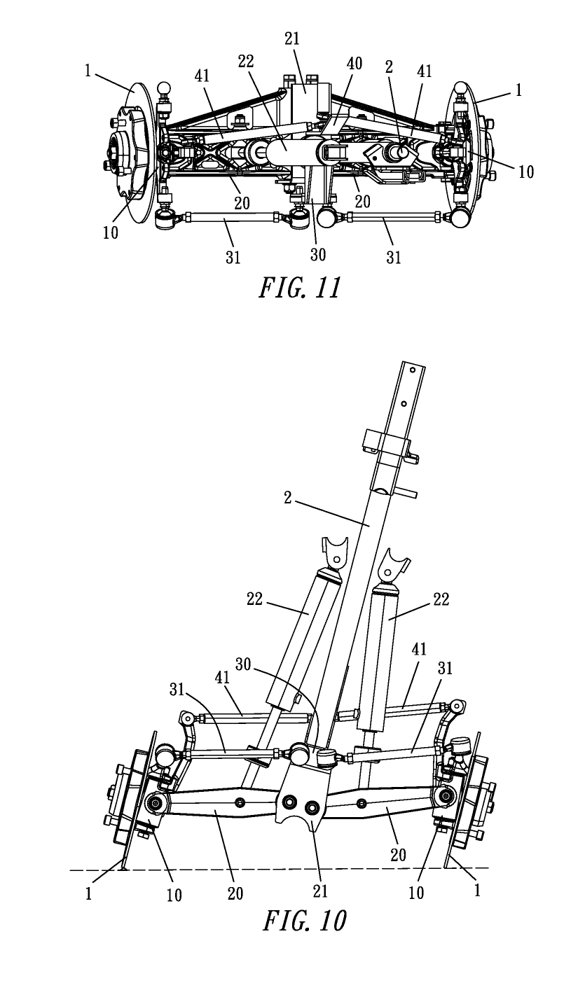

Referring to FIGS. 8 to 11, when the front wheels 1 travel over bumpy roads and either encounters uneven and inclined road surfaces, especially the road surface with height differences, it will move upward to drive the connecting arm 20 attached to the front wheel bracket 10 to move upward with the wheel 1 simultaneously. Thus, the hydraulic damper 22 associated with the wheel encountering uneven and inclined road surfaces will generate the movement of compression and shock-absorption, and because the two hydraulic dampers 22 are interconnected, the hydraulic damper 22 on the other side will supply a downward pressure to its relative wheel 1 so as to keep the two front wheels 1 in contact with the ground surface. Moreover, a displacement occurs to the extension plate 40 when the steering shaft 2 tilts, so that the linkages 41 are pulled to drive the two front wheels 1 to tilt.

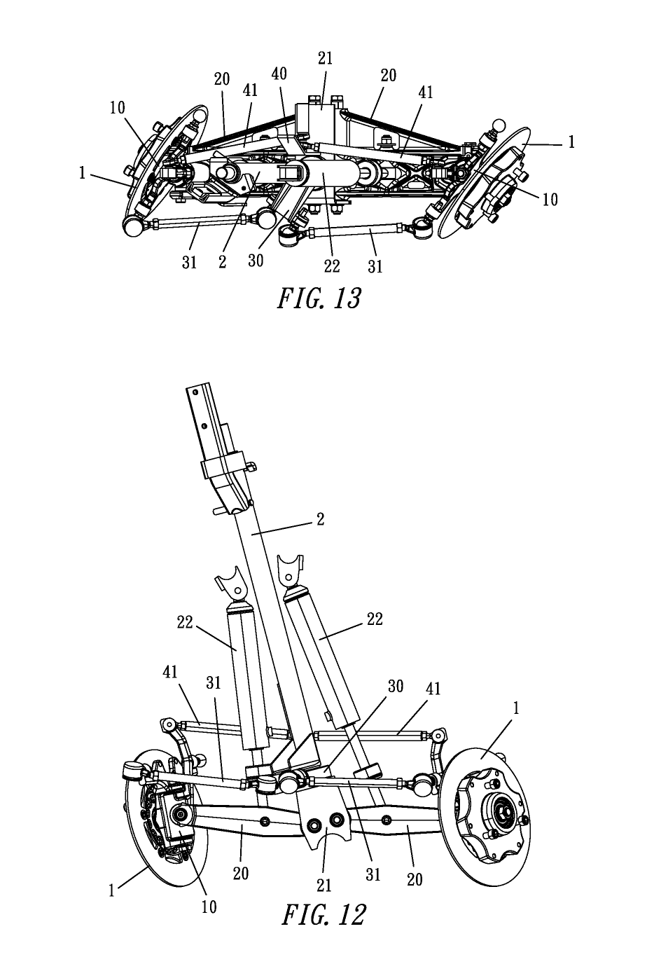

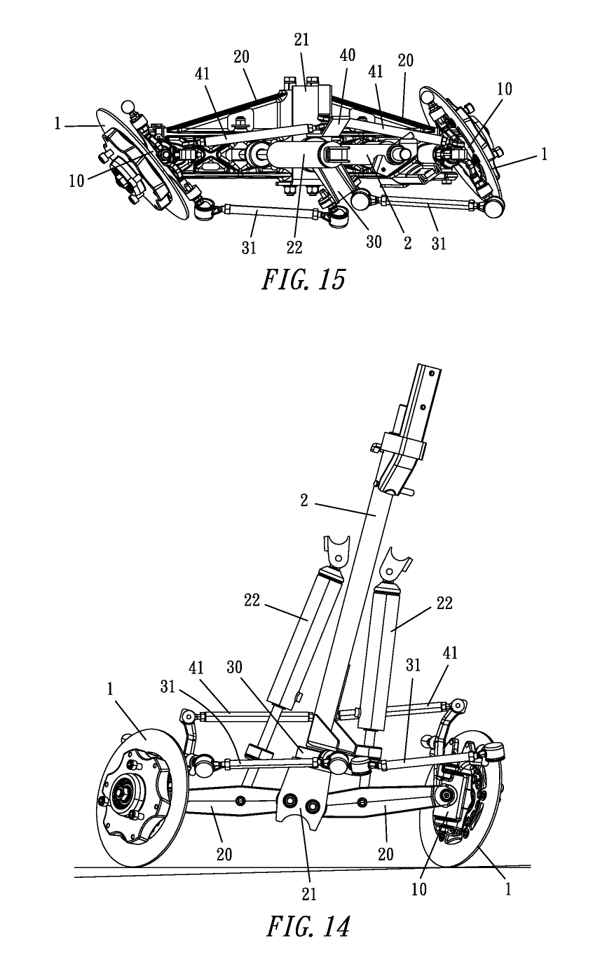

Referring to FIGS. 12 to 15, the steering shaft 2 is turned to drive the two steering linkages 31 to direct the two front wheels to a desired course when the front wheels 1 travel over an inclined road surface with height differences and make turns. Due to the inclined ground surface, the steering shaft 2 performs rotation, and the movement of the rotation causes the displacement of the extension plate 40 further to drive the front wheels 1 to tilt. In addition, the two hydraulic dampers 22 will absorb the shock impulses occurring to the front wheels 1 and enable the surfaces of the front wheels to maintain contact with the ground.

With respect to the above description, it is to be realized that the front wheels disclosed in the present invention, which may not only turn well on a flat road surface but also travel and turn well on an inclined road surface with height differences, may beautifully deal with any operating condition. Moreover, the present invention provides a simple and innovative structure that may reduce cost.

Therefore, the foregoing is considered as illustrative only of the principles of the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A road holding ability mechanism for the two front wheels of a motorcycle, comprising:
two front wheel brackets for supporting the two front wheels respectively coupled with a connecting arm secured to a connecting base between the connecting arms;
a steering shaft attached to a handlebar of the motorcycle for directing the front wheels to a desired direction of motion, wherein the connecting base and the steering shaft are managed by a control system so as to control the connecting base not only to be able to tilt simultaneously with the steering shaft when the shaft tilts but also to be able to stay fixed in the same place without turning simultaneously with the steering shaft when the shaft performs in-place clockwise or counterclockwise rotation;
two shock absorbers whose buffer action forces are interconnected and each of which has a upper end pivotally connected with the motorcycle frame as well as a bottom end secured to the top surface of the relative connecting arm;
an anchor plate attached to the steering shaft so as to be able to simultaneously operate together with the shaft and arranged with a right steering linkage as well as a left steering linkage which are respectively connected to the relative front wheel bracket; and
an extension plate which is provided in coupling with the connecting base so as to be able to simultaneously perform together with the connecting base and which is configured with a right linkage and a left linkage respectively attached to the relative front wheel bracket.

2. The road holding ability mechanism for the two front wheels of a motorcycle as claimed in claim 1, wherein the shock absorbers are the hydraulic dampers and the hydraulic circuits of the two hydraulic dampers are interconnected.
